(19) United States
(12) Patent Application Publication
(10) Pub. No.: US 2008/0036663 A1
(43) Pub. Date: Feb. 14, 2008

(54) Antenna Device

(76) Inventors: Yukio Sakai, Hyogo (JP); Jyouji Fujiwara, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/630,113

(22) PCT Filed: Jun. 15, 2006
(86) PCT No.: PCT/JP06/11990

§ 371 Date: Dec. 20, 2006

(30) Foreign Application Priority Data
Jun. 27, 2005 (JP) 2005-185852

(51) Int. Cl. H01Q 1/38

(52) U.S. Cl. 343/700 MS

(57) ABSTRACT

Antenna device (1) includes substrate (2) having first surface (21), antenna element (3), circuit element (4) and first pattern (6) formed of metal, antenna element (3) is arranged on first surface (21), circuit element (4) is soldered to first surface (21) and electrically connected to antenna element (3), first pattern (6) is arranged between antenna element (3) and circuit element (4) on first surface (21), a distance between antenna element (3) and first pattern (6) is a length equal to or larger than a width of antenna element. In this arrangement, antenna device (1) in which substrate (2) between antenna element (3) and circuit element (4) is reinforced by first pattern (6), and warping of substrate (2) when being taken out from a reflow oven is restrained is provided.

### TECHNICAL FIELD

The present invention relates to an antenna device used for wireless communication such as LAN communication and the like.

### BACKGROUND ART

Referring to FIG. 8, an antenna device in the related art will be described. Antenna device 101 includes substrate 102, antenna 103 and circuit element 104 soldered to substrate 102. Antenna device 101 has space 105 between antenna 103 and circuit element 104. Space 105 is an area where a conductive pattern is not arranged, and is provided so as to prevent emission characteristic of antenna 103 from degrading.

The soldering between substrate 102 and circuit element 104 is performed as follows. Firstly, a solid solder (not shown) is inserted between substrate 102 and circuit element 104. Then, in this state, antenna device 101 is placed in a reflow oven (not shown). The solder which is liquefied by heating substrate 102 in the reflow oven is adhered to circuit element 104. Then, the solder is cooled down and hence cured by taking antenna device 101 out from the reflow oven.

The antenna device in the related art is disclosed, for example, in Japanese Patent Unexamined Publication No. H4-326606.

### DISCLOSURE OF THE INVENTION

There is provided an antenna device in which warp of a substrate due to a heat contraction difference between a solder and a substrate when the antenna device is taken out from a reflow oven is prevented.

The antenna device in the present invention includes a substrate having a first surface, an antenna element, a circuit element and a first pattern formed of metal, the antenna element is arranged on the first surface, the circuit element is soldered to the first surface and is electrically connected to the antenna element, the first pattern is arranged between the antenna element and the circuit element on the first surface, and a distance between the antenna element and the first pattern has a length equal to or larger than a width of the antenna element. In this configuration, there is provided the antenna device in which the substrate between the antenna element and the circuit element is reinforced by the first pattern, and warping of the substrate when being taken out from a reflow oven is restrained.

### BRIEF DESCRIPTION OF DRAWINGS

FIG. 1 is a top view of an antenna device according to a first embodiment.

FIG. 2 is a perspective view of the antenna device shown in FIG. 1.

FIG. 3A is an emission characteristic view of the antenna device shown in FIG. 1.

FIG. 3B is the emission characteristic view of the antenna device shown in FIG. 1.

FIG. 3C is the emission characteristic view of the antenna device shown in FIG. 1.

FIG. 4 is a bottom view of another antenna device according to the first embodiment.

FIG. 5 is a top view of further another antenna device according to the first embodiment.

FIG. 6 is a top view of an antenna device according to a second embodiment.

FIG. 7 is a bottom view of another antenna device according to the second embodiment.

FIG. 8 is a top view of a conventional antenna device.

### DESCRIPTION OF REFERENCE NUMERALS AND SIGNS

1 antenna device
2 substrate
3 first antenna element
4 circuit element
5 space
6 first pattern
7 first feeding point
8 discontinuous portion
9 first portion
9a width of first portion
10 second portion
10a width of second portion
11 distance between first antenna element and circuit element
13 through hole
14 second feeding point
15 antenna switch-over device
16 wireless circuit
17 signal processing circuit
18 control unit
20 information processing apparatus
21 first surface
22 second surface
23 case
26 second pattern

### PREFERRED EMBODIMENTS FOR CARRYING OUT THE INVENTION

### First Embodiment

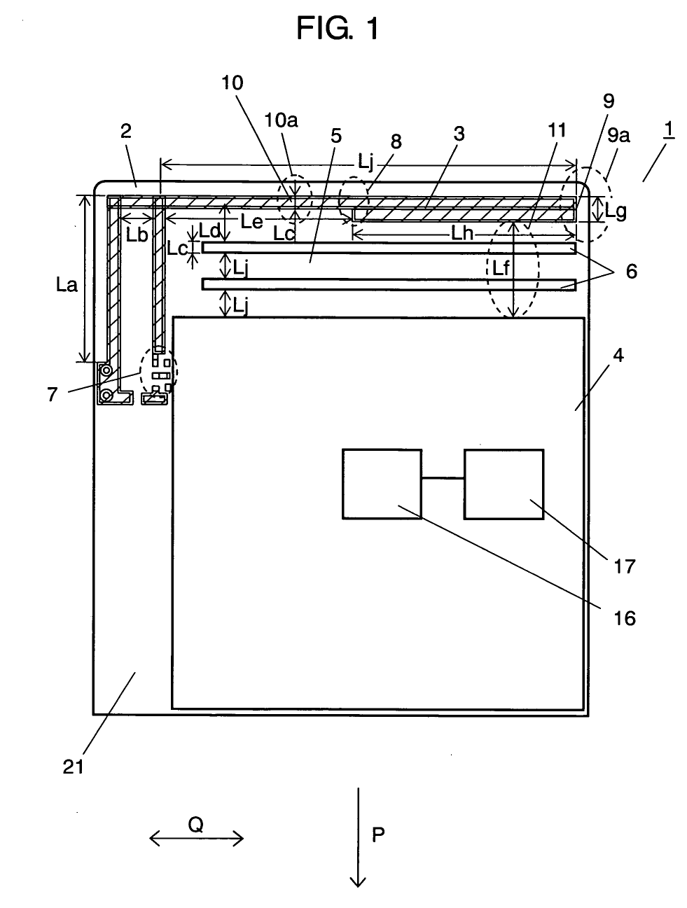

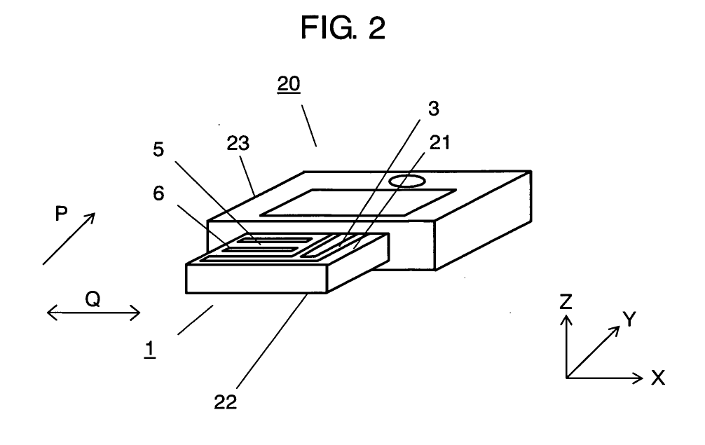

Referring now to FIG. 1 and FIG. 2, antenna device 1 according to a first embodiment will be described.

Antenna device 1 is connected to information processing device 20 such as a personal computer or a cellular phone for being used for wireless communication such as LAN communication. In antenna device 1, first antenna element 3 (hereinafter referred to as antenna 3) and circuit element 4 electrically connected to antenna 3 are provided on first surface 21 (hereinafter referred to as surface 21), which is an upper surface of the substrate 2. First pattern 6 (hereinafter referred to as pattern 6), which is an upper pattern, is provided at space 5 on surface 21. Space 5 is provided on between antenna 3 and circuit element 4.

In FIG. 1, dimensions indicated by alphabet characters are; La=6.4 mm, Lb=1.5 mm, Lc=0.5 mm, Ld=2 mm, Le=7.5 mm, Lf=4 mm, Lg=1 mm, Lh=9 mm, Li=16.5 mm, Lj=0.75 mm, respectively.

Substrate 2 is a multi-layer substrate formed of resin such as glass epoxy or the like. The thickness of substrate 2 is generally 0.4 mm or smaller for achieving low-profile antenna device 1.

Antenna 3 is formed of a conductive material such as copper. Antenna 3 receives high-frequency signals and supplies the received high-frequency signals to circuit element 4 via first feeding point 7 (hereinafter referred to as feeding point 7). In contrast, antenna 3 sends the high-frequency signals supplied from circuit element 4 via feeding point 7. Antenna 3 has a shape such as, for example, an inverted F-shape as shown in FIG. 1 and an L-shape. A width of antenna 3 may vary on reaching discontinuous portion 8. For example, first portion 9 is a portion of antenna 3 having a larger width, and a second portion 10 is a portion of antenna 3 having a smaller width. Width 9a of first portion 9 is about 1.0 mm, and width 10a of second portion 10 is about 0.5 mm.

In this configuration, a characteristic impedance of antenna 3 changes on reaching discontinuous portion 8. Therefore, the length (entire length) of antenna 3 can be shortened. Consequently, downsizing of antenna device 1 is achieved.

Circuit element 4 is soldered onto surface 21 of substrate 2 and is electrically connected to antenna 3. Circuit element 4 includes a circuit such as wireless circuit 16 or signal processing circuit 17. Wireless circuit 16 picks up signals in a desired frequency band out of the high-frequency signals received by antenna 3, converts the picked up signals into intermediate frequency signals, and outputs the converted intermediate frequency signals to signal processing circuit 17. Signal processing circuit 17 demodulates the intermediate frequency signals received from wireless circuit 16 to generate demodulated data signals. Then, signal processing circuit 17 outputs the generated demodulated data signals to information processing device 20 to which antenna device 1 is connected.

A characteristic impedance at feeding point 7 which connects antenna 3 and circuit element 4 is preferably close to 50Ω, which is a characteristic impedance of wireless circuit 16 included in circuit element 4. More specifically, the characteristic impedance at feeding point 7 is preferably 50Ω±10Ω. Accordingly, a mismatch loss of the high-frequency signals at feeding point 7 is restrained.

There is a case where an emission characteristic of antenna 3 may be deteriorated due to an influence of a conductive material which constitutes circuit element 4. Space 5 is provided for restraining the deterioration of the emission characteristic of antenna 3. For example, a width of space 5, that is distance 11 between antenna 3 and circuit element 4, is about 4.0 mm which is about eight times width 10a of second portion 10.

Pattern 6 is formed of metal such as copper or aluminum. Pattern 6 is arranged so that the distance between pattern 6 and antenna 3 is maintained to a length equal to or larger than the width of antenna 3. The width of antenna 3 here indicates width 10a of second portion 10.

As shown in FIG. 1, two patterns 6 are provided substantially in parallel with antenna 3. The deterioration of the emission characteristic of antenna 3 is restrained by patterns 6 formed of metal. In addition, patterns 6 have an effect to mechanically reinforce a portion of substrate 2, which is disposed at between antenna 3 and circuit element 4. Consequently, a warping of substrate 2 when antenna device 1 is taken out from a reflow oven is restrained. Therefore when substrate 2 is inserted into case 23, substrate 2 is prevented from being applied with a stress from case 23, and generation of a stress in the direction of separating a joint between circuit element 4 and substrate 2 is restrained. Accordingly, circuit element 4 can hardly separate from substrate 2.

In particular, when patterns 6 are provided in the lateral direction with respect to direction P of insertion of substrate 2 as shown in FIG. 1, substrate 2 is prevented from warping in lateral direction Q. The number of patterns 6 is not limited. They do not have to be arranged necessarily in parallel with antenna 3. Pattern 6 may be of any shape as long as the distance between pattern 6 and antenna 3 is maintained to a distance which is equal to or larger than the width of antenna 3.

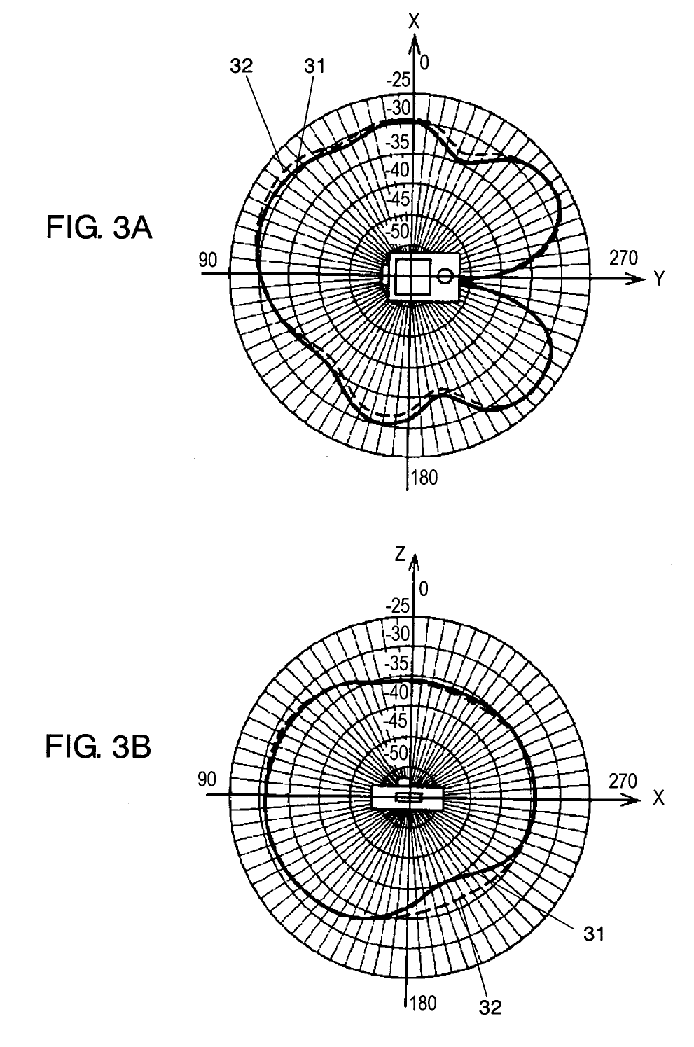

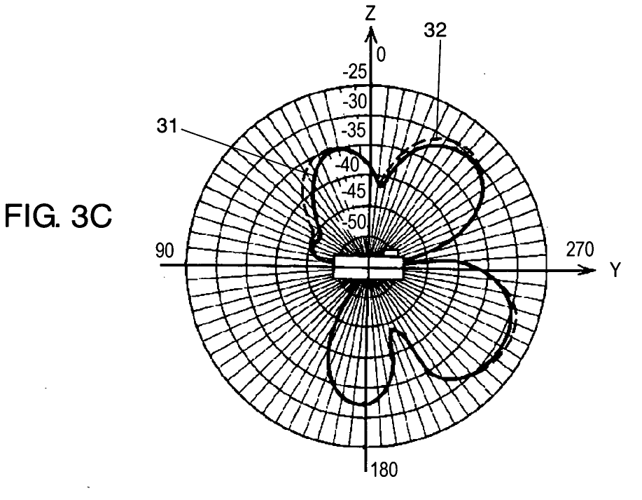

Subsequently, referring to the drawing, the emission characteristic of antenna device 1 will be described, when antenna device 1 is inserted into information processing apparatus 20. FIG. 2 is a perspective view showing the information processing apparatus in a XYZ space and the antenna device inserted into the information processing apparatus. Surface 21 of antenna device 1 is oriented in the positive direction of the Z-axis of the XYZ space. FIG. 3A, FIG. 3B and FIG. 3C are emission characteristic views in which the emission characteristics of antenna 3 in a XY plane, XZ plane and YZ plane in FIG. 2 are indicated by solid lines 31. In FIG. 3A, FIG. 3B and FIG. 3C, the emission characteristics of a conventional antenna device, which does not have patterns 6, is shown with broken lines 32 for comparison. As is clear from FIG. 3A, FIG. 3B and FIG. 3C, there is no much difference between the emission characteristic of antenna device 1 shown by solid lines 31 and the emission characteristic of the conventional antenna device shown by broken lines 32. Therefore, it is understood that the emission characteristic of antenna 3 is degraded little even when patterns 6 formed of metal are arranged at the distance from antenna 3 by equal to the width of antenna 3 or larger.

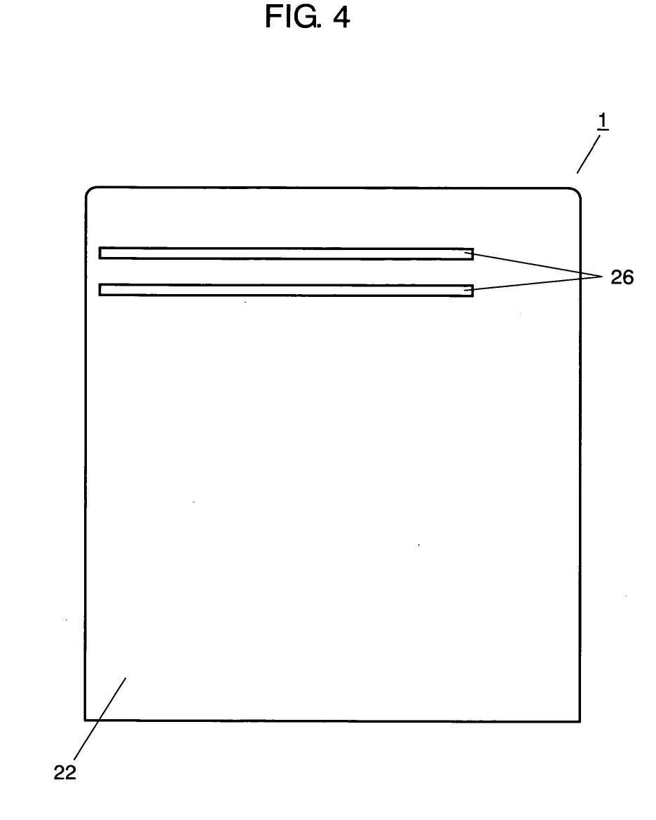

FIG. 4 is a bottom view of another antenna device according to the first embodiment. As shown in FIG. 4, second surface 22, which corresponds to the lower surface of substrate 2, is provided with second pattern 26 (hereinafter referred to as pattern 26) as a lower pattern. Surface 22 is located on the back side of surface 21 on which patterns 6 are provided. The size of pattern 26 is substantially the same as the size of pattern 6. The position, where pattern 26 is arranged, is a position where the position, where the pattern 6 is arranged, is substantially projected. In this arrangement, a portion of substrate 2 which is disposed at between antenna 3 and circuit element 4 is interposed between pattern 6 and pattern 26. Accordingly, the portion of substrate 2 which is disposed at between antenna 3 and circuit element 4 is further reinforced. Consequently, the warping of substrate 2 when antenna device 1 is taken out from the reflow oven is further restrained.

Preferably, a coefficient of thermal expansion of a material which constitutes pattern 6 and a coefficient of thermal expansion of a material which constitutes pattern 26 are substantially equal. When the coefficients of thermal expansion of the respective materials are substantially equal, pattern 6 and pattern 26 expand substantially equally when antenna device 1 is put in the reflow oven. Consequently, occurrence of the warping of substrate 2 when antenna device 1 is put in the reflow oven is restrained.

Further, it is preferable that a shape of pattern 26 is substantially equal to a shape of pattern 6. It is also preferable that the material which constitutes pattern 26 is substantially the same as the material which constitutes pattern 6. Accordingly, when antenna device 1 is put in the reflow oven, pattern 6 and pattern 26 expand further equally, and the warping of substrate 2 when antenna device 1 is put in the reflow oven is further restrained.

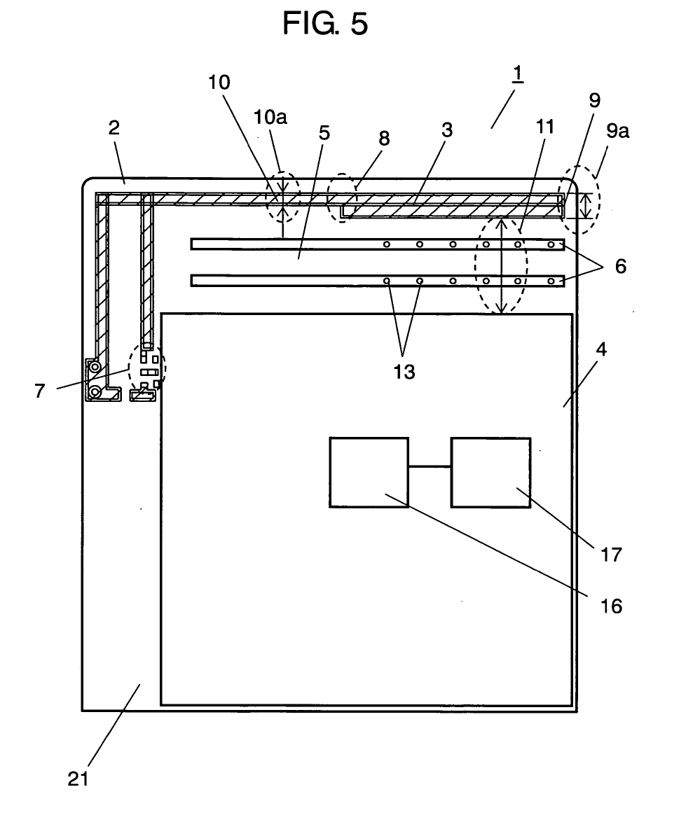

FIG. 5 shows a top view of further another antenna device according to the first embodiment. As shown in FIG. 5, antenna device 1 is provided with through hole 13 which penetrates from surface 21 to surface 22. Pattern 6 and pattern 26 are connected via through hole 13. In this arrangement, pattern 6 and pattern 26 are integrated to sandwich substrate 2. Accordingly, the warping of substrate 2, when antenna device 1 is taken out from the reflow oven, is restrained further reliably. Pattern 6 or pattern 26 is restrained from separating from substrate 2 by an external force such as a stress applied from the outside to antenna device 1. Any number of through holes 13 may be provided. It may be determined as needed according to a size of antenna device 1 and the size of pattern 6 or pattern 26.

The connection between pattern 6 and pattern 26 via through hole 13 is a connection achieved mechanically and electrically. However, the electrical connection is not necessarily required.

### Second Embodiment

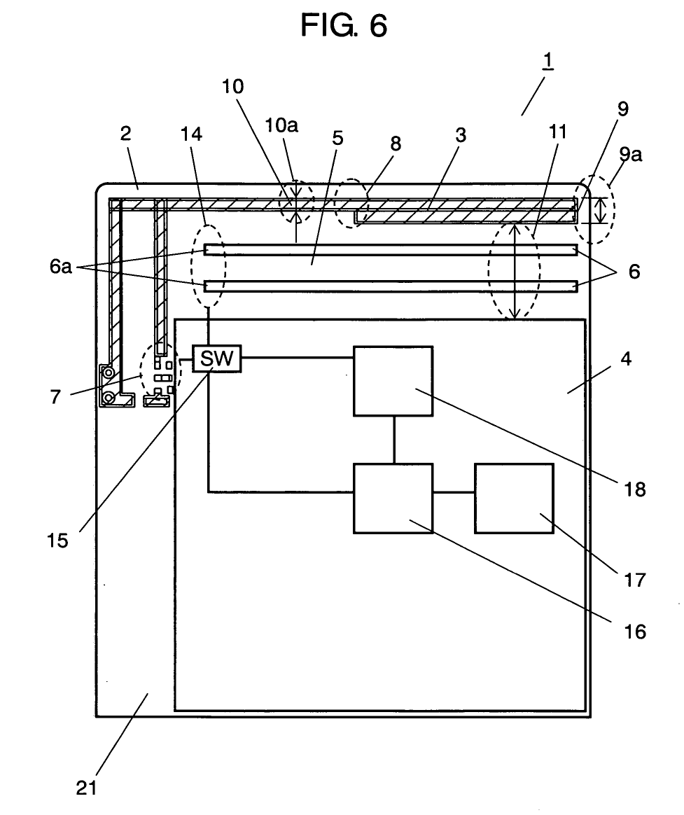

FIG. 6 is a top view of an antenna device according to a second embodiment. The same parts as the first embodiment are represented by the same reference numerals as the first embodiment, and will not be specifically described.

In FIG. 6, second feeding point 14 (hereinafter referred to as feeding point 14) is provided between end portion 6a of pattern 6 and circuit element 4. Feeding point 14 is connected to antenna switch-over device 15 provided on the circuit element 4. Pattern 6 receives high-frequency signals and supplies the received high-frequency signals to the circuit element 4 via the feeding point 14. In contrast, pattern 6 sends the high-frequency signals supplied from circuit element 4 via feeding point 14. Accordingly, pattern 6 serves as a second antenna element.

Antenna switch-over device 15 is connected to the respective Input/Output terminals of feeding point 7 and feeding point 14. Circuit element 4 further includes control unit 18. Antenna switch-over device 15 switches between the high-frequency signals supplied from feeding point 7 and the high-frequency signals supplied from feeding point 14 and supplies the same to circuit element 4. In contrast, antenna switch-over device 15 switches high-frequency signals supplied from circuit element 4 and supplies the same to feeding point 7 or feeding point 14. Those switching by antenna switch-over device 15 are performed with based on control signals from control unit 18. In other words, wireless circuit 16 included in circuit element 4 receives the high-frequency signals from antenna 3 and the high-frequency signals from pattern 6 so as to receive a high-frequency signal based on a diversity system. In the same manner, antenna device 1 sends the high-frequency signals. The diversity system includes, for example, a time diversity system, a space diversity system, a polarization diversity system, or/and a frequency diversity system. In this arrangement, the emission characteristic of antenna device 1 is improved.

In particular, when antenna device 1 is used for such as a memory card-type wireless device, small-type antenna device 1 is required. When the size of antenna device 1 is small, the receiving characteristic of antenna device 1 tends to be degraded. However, with the configuration which has the pattern 6 having feeding point 14 and the antenna switch-over device 15 electrically connected to feeding points 7, 14, the receiving characteristic of antenna device 1 is further improved.

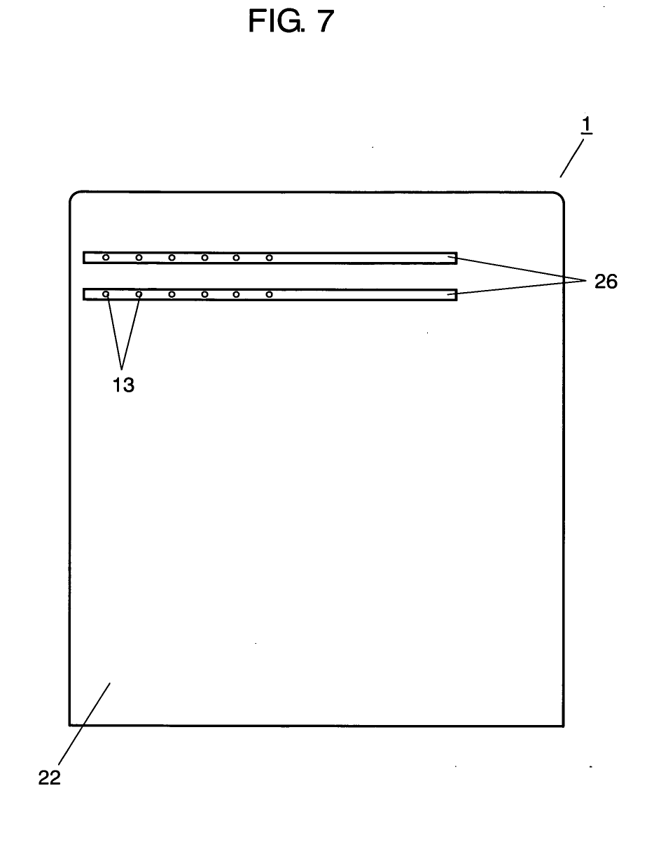

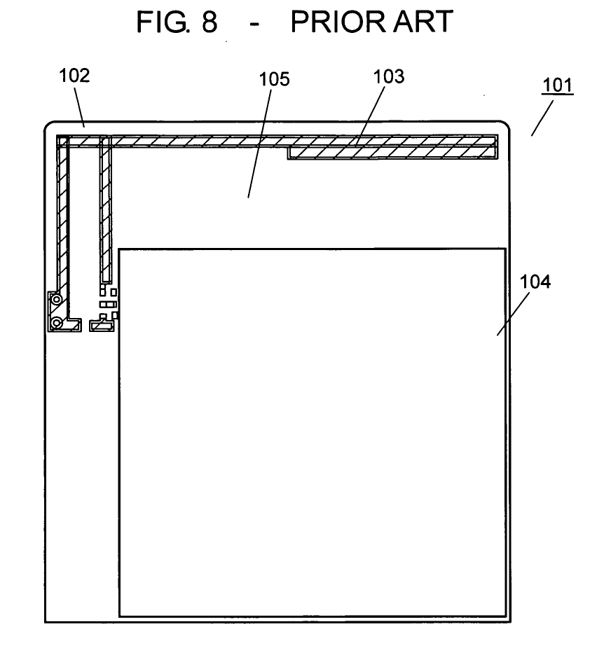

FIG. 7 is a bottom view of another antenna device according to the second embodiment. As shown in FIG. 7, it is also possible to provide second pattern 26 corresponding to first pattern 6 and provide through hole 13 which connects respective patterns 6 and 26. Accordingly, the same action and effect as described in the first embodiment will be obtained.

The connection between pattern 6 and pattern 26 via through hole 13 is the connection achieved mechanically and electrically. However, the electrical connection is not necessarily required. When pattern 6 and pattern 26 are electrically connected, pattern 26 serves as the second antenna element like pattern 6.

### INDUSTRIAL APPLICABILITY

The antenna device according to the present invention is configured in such a manner that the lowering of the emission characteristic and the warping of the substrate are restrained, and is applicable in wireless communication such as the LAN communication and further in a wireless communication system in which a high-quality communication performance is required.

1. An antenna device comprising:
a substrate having a first surface;
an antenna element arranged on the first surface;
a circuit element soldered on the first surface and electrically connected to the antenna element; and
a first pattern formed of metal arranged between the antenna element and the circuit element on the first surface,
wherein a distance between the antenna element and the first pattern is equal to or longer than a width of the antenna element.

2. The antenna device of claim 1, further comprising:
a second pattern having substantially the same size as the first pattern,
wherein the substrate further has a second surface, which is a back surface of the first surface, and
wherein the second pattern is arranged on the second surface.

3. The antenna device of claim 2,
wherein a coefficient of thermal expansion of a material which constitutes the first pattern and a coefficient of thermal expansion of a material which constitutes the second pattern are substantially the same each other.

4. The antenna device of claim 2, further comprising:
a through hole penetrating from the first surface to the second surface,
wherein the first pattern and the second pattern are connected via the through hole.

5. The antenna device of claim 1, further comprising:
a first feeding point connected to the antenna element;
a second feeding point connected to the first pattern; and
an antenna switch-over device connected to the first feeding point and the second feeding point for switching between the first feeding point and the second feeding point.

6. The antenna device of claim 1,
wherein the circuit element switches between a signal from the antenna element and a signal from the first pattern, and receives so as to receive a high-frequency signal based on a diversity system.
